(19) United States
(12) Patent Application Publication
(10) Pub. No.: US 2026/0106749 A1
(43) Pub. Date: Apr. 16, 2026

(54) DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Masafumi IWASHIRO, Yokohama Kanagawa (JP); Yusuke KUBOTA, Kawasaki Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/190,943

(22) Filed: Apr. 28, 2025

(30) Foreign Application Priority Data
Oct. 11, 2024 (JP) 2024-179321

(51) Int. Cl. H04L 9/08

(52) U.S. Cl. CPC H04L 9/088

(57) ABSTRACT

According to one embodiment, a disk device including a disk medium, a volatile memory, and a controller is provided. First data is written to the disk medium. The first data includes an encryption key. The volatile memory can temporarily store second data. The controller includes a processor and a non-volatile memory. The processor encrypts the second data with the encryption key when power interruption occurs. The non-volatile memory stores the encrypted second data when the power interruption occurs.

### CROSS-REFERENCE TO RELATED APPLICATIONS

This application is based upon and claims the benefit of priority from Japanese Patent Application No. 2024-179321, filed on Oct. 11, 2024; the entire contents of which are incorporated herein by reference.

### FIELD

Embodiments described herein relate generally to a disk device.

### BACKGROUND

In a disk device, when power interruption occurs, unwritten data may be backed up. In the disk device, it is desirable that data backup is appropriately performed.

### BRIEF DESCRIPTION OF THE DRAWINGS

FIG. 1 is a diagram illustrating a schematic configuration of a disk device according to an embodiment;

FIG. 2 is a diagram illustrating a detailed configuration of the disk device according to the embodiment;

FIG. 3 is a flowchart illustrating an operation related to power interruption of the disk device according to the embodiment;

FIGS. 4A to 4C are diagrams illustrating registered contents of address translation information according to the embodiment;

FIGS. 5A to 5C are diagrams illustrating registered contents of address translation information according to the embodiment; and

FIG. 6 is a flowchart illustrating an operation related to power restoration of the disk device according to the embodiment.

### DETAILED DESCRIPTION

In general, according to one embodiment, there is provided a disk device including a disk medium, a volatile memory and a controller. To the disk medium first data is written. The volatile memory is capable of temporarily storing the first data and second data. The controller includes a processor and a non-volatile memory. The processor acquires at least part of the first data as an encryption key when power interruption occurs and encrypting the second data with the encryption key. The non-volatile memory stores the encrypted second data when the power interruption occurs.

Exemplary embodiments of a disk device will be explained below in detail with reference to the accompanying drawings. The present invention is not limited to the following embodiments.

### Embodiment

In a disk device according to an embodiment, although data that has not been written is backed up when power interruption occurs, an improvement for appropriately performing data backup is made.

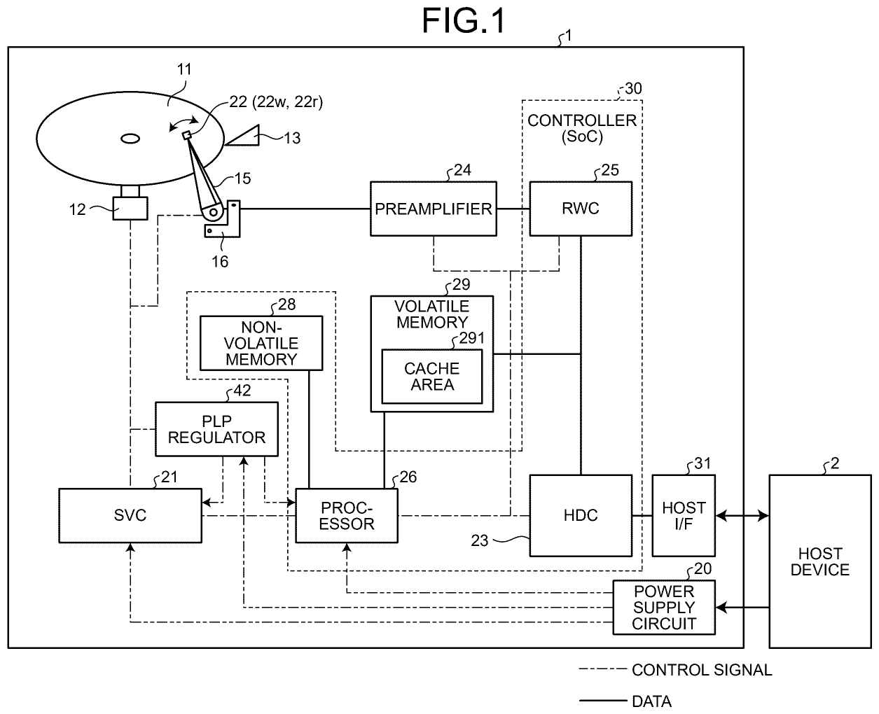

A disk device 1 can be configured as illustrated in FIG. 1. FIG. 1 is a diagram illustrating a configuration of the disk device 1.

The disk device 1 can be connected to and communicate with a host device 2 via a communication medium. The disk device 1 is connected to the host device 2 and functions as an external storage medium for the host device 2.

The disk device 1 includes a disk medium 11, a spindle motor (SPM) 12, a lamp 13, an actuator arm 15, a voice coil motor (VCM) 16, a power supply circuit 20, a servo controller (SVC) 21, a head 22, a host interface (host I/F) 31, a preamplifier 24, a volatile memory 29, a power loss protection (PLP) regulator 42, and a controller 30.

The controller 30 integrally controls each unit of the disk device 1. The controller 30 includes a hard disk controller (HDC) 23, a read/write channel (RWC) 25, a processor 26, and a non-volatile memory 28. The controller 30 may be configured as a system-on-a-chip (SoC).

The disk medium 11 is a disk-type storage medium, and may be a magnetic disk or a magneto-optical disk. In a case where the disk medium 11 is a magnetic disk, a magnetic layer is formed on a surface thereof, and information can be recorded in a magnetization direction.

The disk medium 11 is rotatably supported by a housing (not illustrated) of the disk device 1 via the SPM 12.

The power supply circuit 20 distributes power supplied from the host device 2 to each component of the disk device 1 as indicated by two-dot chain line arrows in FIG. 1. Although the SVC 21, the processor 26, and the PLP regulator 42 are exemplified as destinations of power supply by the power supply circuit 20 in FIG. 1, power may also be supplied to other components from the power supply circuit 20. The power supply circuit 20 may convert a voltage according to a destination of power supply. Note that the power supply circuit 20 may receive power supply from a power supply device or may receive power supply from a system instead of the host device 2.

The SVC 21 functions as a driver that drives the SPM 12 and the VCM 16. The SVC 21 may be configured as an integrated circuit.

The head 22 writes and reads information to and from the disk medium 11 by a write element 22w and a read element 22r provided therein. Furthermore, the head 22 is attached to a distal end of the actuator arm 15. The head 22 is moved in a radial direction of the disk medium 11 by the VCM 16 driven by the SVC 21. Note that, any one of the write element 22w or the read element 22r provided in the head 22 may be provided as multiple write elements 22w or multiple read elements 22r, or both may be provided as the multiple write elements 22w and the multiple read elements 22r with respect to the single head 22.

For example, when the rotation of the disk medium 11 is stopped, the head 22 is moved onto the lamp 13. The lamp 13 is configured to hold the head 22 at a position spaced apart from the disk medium 11.

The preamplifier 24 enables the head 22 to write and read data. The preamplifier 24 may be configured as an integrated circuit. The preamplifier 24 amplifies and outputs a signal read from the disk medium 11 by the head 22, and supplies the amplified signal to the RWC 25 during a read operation. Furthermore, the preamplifier 24 amplifies a signal corresponding to data to be written, which is supplied from the RWC 25, and supplies the amplified signal to the head 22 during a write operation.

The volatile memory 29 is used as a buffer for data to be transmitted to and received from the host device 2. That is, a cache area 291 is allocated to the volatile memory 29, and the volatile memory 29 functions as a cache memory. The cache area 291 is used to temporarily store data to be written, which has not yet been written to the disk medium 11, among data received from the host device 2. Furthermore, the volatile memory 29 is used to temporarily store data read from the disk medium 11.

Moreover, the processor 26 uses the volatile memory 29 as an operation memory. The volatile memory 29 is used as an area in which firmware is loaded and an area in which various types of management data are temporarily stored. The volatile memory 29 may be a dynamic random access memory (DRAM).

The non-volatile memory 28 stores information in a non-volatile manner. In a management information storage area of the non-volatile memory 28, firmware (program data), various operation parameters, and the like may be stored. The firmware may be stored in a management information storage area of the disk medium 11 instead of the non-volatile memory 28.

The non-volatile memory 28 and the volatile memory 29 are connected to the processor 26. In a case where the firmware is read from the management information storage area of the non-volatile memory 28 or the disk medium 11, the processor 26 performs overall control of the disk device 1 according to the firmware.

For example, the processor 26 loads the firmware from the non-volatile memory 28 or the disk medium 11 into the volatile memory 29, and executes control of the SVC 21, the preamplifier 24, the RWC 25, the HDC 23, and the like according to the firmware loaded into the volatile memory 29. The processor 26 controls rotation of the SPM 12 via the SVC 21. The processor 26 controls driving of the VCM 16 via the SVC 21. The processor 26 may include a central processing unit (CPU).

The host I/F 31 can be connected to the host device 2 via a communication medium. The host I/F 31 functions as a communication interface with the host device 2.

The HDC 23 controls transmission and reception of data to and from the host device 2 via the host I/F 31, controls the volatile memory 29, and the like.

For example, when the disk device 1 starts to operate, the processor 26 reads pieces of address translation information 32 and 33 from the management information storage area of the non-volatile memory 28 or the disk medium 11 and stores the pieces of address translation information 32 and 33 in the cache area 291.

The address translation information 32 is information in which a logical address and a physical address of the disk medium 11 are associated with each other. The address translation information 32 may have a data structure in a table format. The logical address is a logical address included in a command and can be specified by the host device 2.

The physical address of the disk medium 11 is a physical address indicating a storage location in the disk medium 11, and can be allocated by the processor 26. The physical address includes, for example, a combination of a cylinder number and a sector number. The cylinder number is a number for identifying a cylinder. The cylinder is a storage area unit across multiple tracks in multiple disk media 11, the tracks corresponding to each other in the vertical direction. The sector number is a number for identifying a sector position in one track.

That is, some pieces of information of the physical address are continuously allocated within each track and across the multiple tracks adjacent to each other in the disk media 11. Note that the physical address includes a head number (recording surface number), and can be continuously allocated across the multiple tracks vertically adjacent to each other in the cylinder.

The address translation information 33 is information in which a logical address and a physical address of the non-volatile memory 28 are associated with each other. The address translation information 33 may have a data structure in a table format. The logical address is a logical address included in a command and can be specified by the host device 2.

The physical address of the non-volatile memory 28 is a physical address indicating a storage location in the non-volatile memory 28, and can be allocated by the processor 26. The physical address includes, for example, a memory package number, a memory die number, a block address, a page address, and a location in a page.

The non-volatile memory 28 includes multiple memory packages and a controller. Each memory package includes multiple memory dies. Each memory die includes multiple blocks. Each block includes multiple pages. In each memory die, data is written and read in units of pages, and data is erased in units of blocks. Each of the memory package number, the memory die number, the block address, the page address, and the position in a page is allocated by the controller in the non-volatile memory 28, and the controller 30 of the disk device 1 is notified of the allocated result.

The HDC 23 can receive an access command from the host device 2 via the host I/F 31. The access command includes a write command and a read command. The HDC 23 provides the received access command to the processor 26 and/or the RWC 25.

In a case where the access command is a write command, the processor 26 performs command processing on the write command including a write instruction, a logical address, and write data. In response to the write instruction, the processor 26 registers a logical address included in the write command into the address translation information 32. The processor 26 allocates a physical address of the disk medium 11 to the logical address, and updates the address translation information 32 accordingly. As a result, the processor 26 completes the command processing. In a case where the command processing is completed, the processor 26 accesses a location corresponding to the physical address of the disk medium 11 and writes the write data via the preamplifier 24 and the head 22.

In a case where the access command is a read command, the processor 26 performs command processing on the read command including a read instruction and a logical address. In response to the read instruction, the processor 26 refers to the address translation information 32 in the cache area 291 and acquires the physical address corresponding to the logical address included in the read command. As a result, the processor 26 completes the command processing. In a case where the command processing is completed, the processor 26 accesses a location corresponding to the physical address of the disk medium 11 and reads the data via the preamplifier 24 and the head 22.

The RWC 25 code-modulates the write data stored in the cache area 291 according to the write instruction supplied from the HDC 23 and/or the processor 26, and writes the code-modulated data to a location corresponding to the physical address of the disk medium 11 via the preamplifier 24.

In response to the read instruction supplied from the HDC 23 and/or the processor 26, the RWC 25 performs code demodulation including error correction on a signal that is read from a location corresponding to the physical address of the disk medium 11 and is supplied from the preamplifier 24. The RWC 25 outputs the code-demodulated signal to the HDC 23 as digital data.

Although the disk device 1 operates with power from the host device 2, the power supply from the host device 2 may be interrupted. On the other hand, the disk device has a PLP function. The PLP function is a function of protecting the disk device 1 so as to reduce the impact of power supply interruption from the host device 2.

The PLP regulator 42 can supply power to the SVC 21 according to the PLP function as indicated by two-dot chain line arrows in FIG. 1.

In a case where the power supply from the host device 2 is interrupted, the disk device 1 generates a signal indicating power interruption and supplies the signal to the PLP regulator 42. The SPM 12 rotates by inertia and can generate regenerative energy by a counter-electromotive force due to the rotation. The PLP regulator 42 receives the regenerative energy from the SPM 12 in response to the signal indicating power interruption. Then, the PLP regulator 42 generates power based on the regenerative energy, and supplies the generated power to the SVC 21 and the processor 26. The PLP regulator 42 may further supply the generated power to other components in the disk device 1.

In a case where the interruption of power supply from the host device 2 is detected during the writing, the PLP function is to prevent, by backing up data that is being written in the cache area 291 of the volatile memory 29 to a non-volatile storage area, the loss of the data from the disk device 1.

Here, it is difficult to use the disk medium 11 as the non-volatile storage area. The amount of the regenerative energy recovered by the PLP regulator 42 is limited because the disk medium 11 rotates by its inertia. Therefore, in a case where the disk medium 11 that takes a relatively long time for the write operation is selected as a backup destination, the data that is being written cannot be backed up completely.

For example, the disk device 1 may be requested not to store data in the non-volatile memory 28 for security assurance. In this case, it is difficult to back up the data in the cache area 291 as is to the non-volatile memory 28 as processing of the PLP function.

Therefore, in the present embodiment, in the disk device 1, the data that is being written is encrypted with the written encryption key and is backed up to the non-volatile memory 28 when the power interruption occurs, to achieve both the security assurance and the backup implementation of the data that is being written.

When the power interruption occurs, the controller 30 acquires at least part of data D1 that has been written in the disk medium 11 as an encryption key. The controller 30 encrypts data D2 that is being written with the encryption key. The controller 30 stores the encrypted data D2 in the non-volatile memory 28 in the controller 30. The controller 30 further stores address information of the data D1 and address information of the data D2 in the non-volatile memory 28. As a result, the data D2 can be backed up to the non-volatile memory 28 while security assurance for the data D2 that is being written is achieved, and a backup of the data D2 can be appropriately performed.

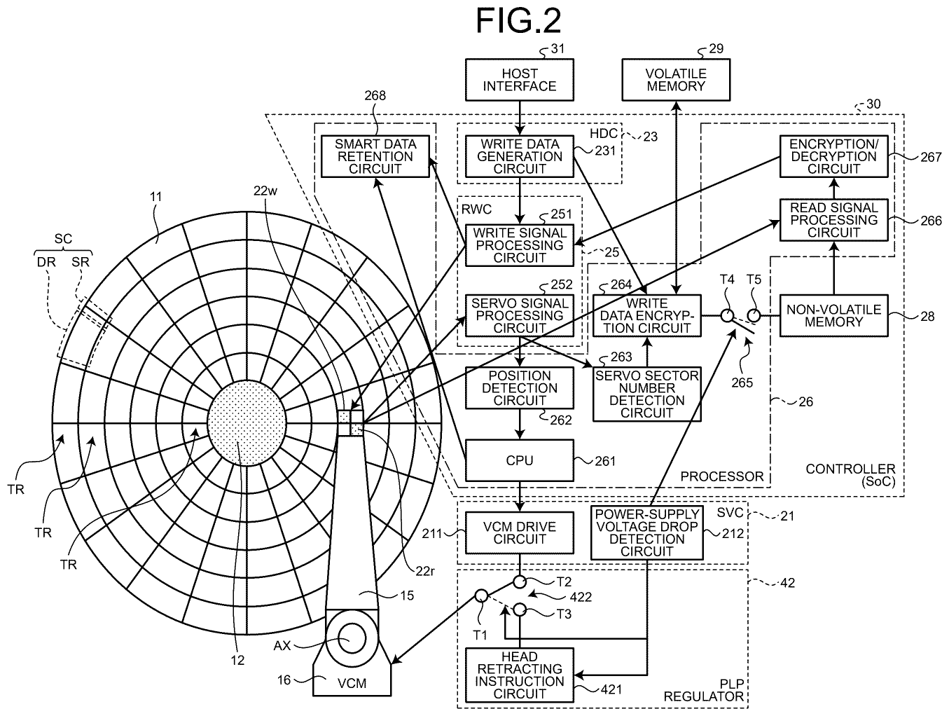

Regarding the PLP function, the disk device 1 can be configured as illustrated in FIG. 2. FIG. 2 is a diagram illustrating a detailed configuration of the disk device 1. FIG. 2 illustrates a configuration of a servo system and a data circuit system of the disk device 1.

The SVC 21 includes a VCM drive circuit 211 and a power-supply voltage drop detection circuit 212. The PLP regulator 42 includes a head retracting instruction circuit 421 and a switch 422. The HDC 23 includes a write data generation circuit 231. The RWC 25 includes a write signal processing circuit 251 and a servo signal processing circuit 252. The processor 26 includes a CPU 261, a position detection circuit 262, a servo sector number detection circuit 263, a write data encryption circuit 264, a switch 265, a read signal processing circuit 266, an encryption/decryption circuit 267, and a SMART (Self-Monitoring Analysis and Reporting Technology) data retention circuit 268.

A physical address is specified in an area referred to as a track TR in a circumferential direction, and an area referred to as a sector SC in a radial direction, on the disk medium 11. Moreover, the sector SC is divided into a servo area SV in which position information is recorded and a data area DR in which user data is recorded. The disk medium 11 is rotated by the SPM 12. The head 22 is attached to one distal end of the actuator arm 15, and the VCM 16 is attached to the other distal end. The actuator arm 15 can rotate about an axis AX to cause the head 22 to perform seek movement from an outer peripheral area to an inner peripheral area on the disk medium 11. Information on the disk medium 11 is read by the read element 22r, and the position of the head 22 is detected by the servo signal processing circuit 252 and the position detection circuit 262. The control calculation is performed by the CPU 261, followed by addition of a current indication value to the VCM drive circuit. A current is generated by the VCM drive circuit 211, and the actuator arm 15 is driven.

The write data generation circuit 231 receives write data via the host interface 31, performs data modification necessary for magnetic recording, and supplies the modified data to the write signal processing circuit 251. The write signal processing circuit 251 drives the write element 22w to write data on the disk medium 11. The SMART data retention circuit 268 monitors the integrity of the disk device 1 by recording a write data state, head positioning data retained by the CPU 261, and track/sector information for each event such as the occurrence of abnormality.

The power-supply voltage drop detection circuit 212 is used to detect power interruption and notifies each peripheral circuit of the power interruption. In response to the power interruption notification, the switch 422 switches from a state in which a terminal T1 and a terminal T2 are connected (a state indicated by a solid line) to a state in which the terminal T1 and a terminal T3 are connected (a state indicated by a dotted line). The head retracting instruction circuit 421 generates a VCM operation amount for instructing a head movement in response to the power interruption notification, and supplies the VCM operation amount to the VCM 16 via the switch 422. In response to the power interruption notification, the switch 265 switches from a state in which a terminal T4 and a terminal T5 are cut off (a state indicated by a solid line) to a state in which the terminal T4 and the terminal T5 are connected (a state indicated by a dotted line).

The controller 30 is an integrated semiconductor chip referred to as SoC, and various functions may be mounted thereon. The non-volatile memory 28 is mounted on a part thereof. The non-volatile memory 28 only requires a storage capacity sufficient to back up data, and may have a relatively small storage capacity.

In the write operation, the write data generation circuit 231 supplies the write data to the write data encryption circuit 264. The write data encryption circuit 264 acquires, via the controller 30, write data that was subjected to command processing immediately before the current write data from the volatile memory 29. The write data encryption circuit 264 extracts at least part of the write data that was subjected to the command processing immediately before, and encrypts the current write data with the extracted data as an encryption key.

The write data encryption circuit 264 backs up and stores the logical address of the encryption key, the encrypted data, and the logical address thereof into the non-volatile memory 28 in the controller 30 when the power interruption occurs.

After power restoration, in the rewrite operation, the read signal processing circuit 266 acquires the logical address of the encryption key, the encrypted data, and the logical address thereof from the non-volatile memory 28. The read signal processing circuit 266 reads the write data including the encryption key from the disk medium 11 according to the logical address of the encryption key, and reproduces the encryption key according to the read data. The read signal processing circuit 266 supplies the encryption key, the encrypted data, and the logical address thereof to the encryption/decryption circuit 267. The encryption/decryption circuit 267 decrypts the encrypted data with the encryption key. In a case where the decryption is completed successfully, the encryption/decryption circuit 267 supplies the decrypted data to the write signal processing circuit 251. The write signal processing circuit 251 generates a write signal according to the decrypted data and writes the write signal to the disk medium 11 via the write element 22w. As a result, the rewriting of the data backed up in the non-volatile memory 28 to the disk medium 11 is completed.

In a case where the decryption fails, the encryption/decryption circuit 267 notifies the SMART data retention circuit 268 of the fact that the decryption fails, and the logical address thereof via the write signal processing circuit 251. The SMART data retention circuit 268 retains SMART data including various diagnosis results regarding the state of the disk device 1. Upon receiving the notification, the SMART data retention circuit 268 reflects the fact that the decryption of the decrypted data has failed and the logical address thereof in the SMART data and performs updating. As a result, the data that has been backed up in the non-volatile memory 28 is managed as having been lost because the data is unable to be decrypted.

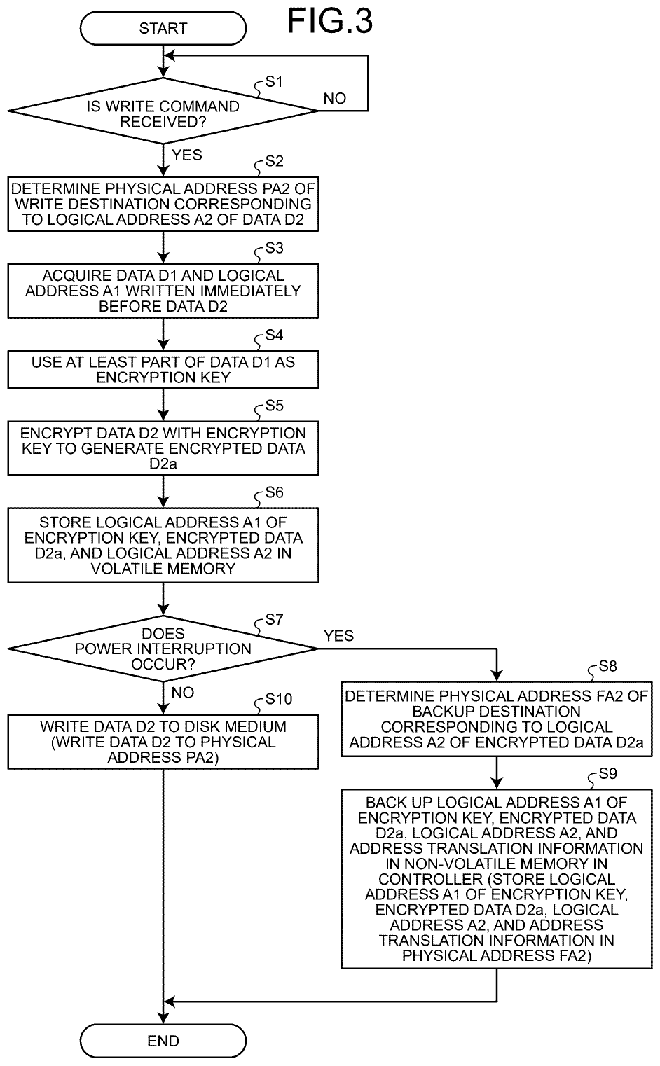

The disk device 1 may perform an operation as illustrated in FIG. 3 related to the power interruption. FIG. 3 is a flowchart illustrating an operation related to power interruption of the disk device 1.

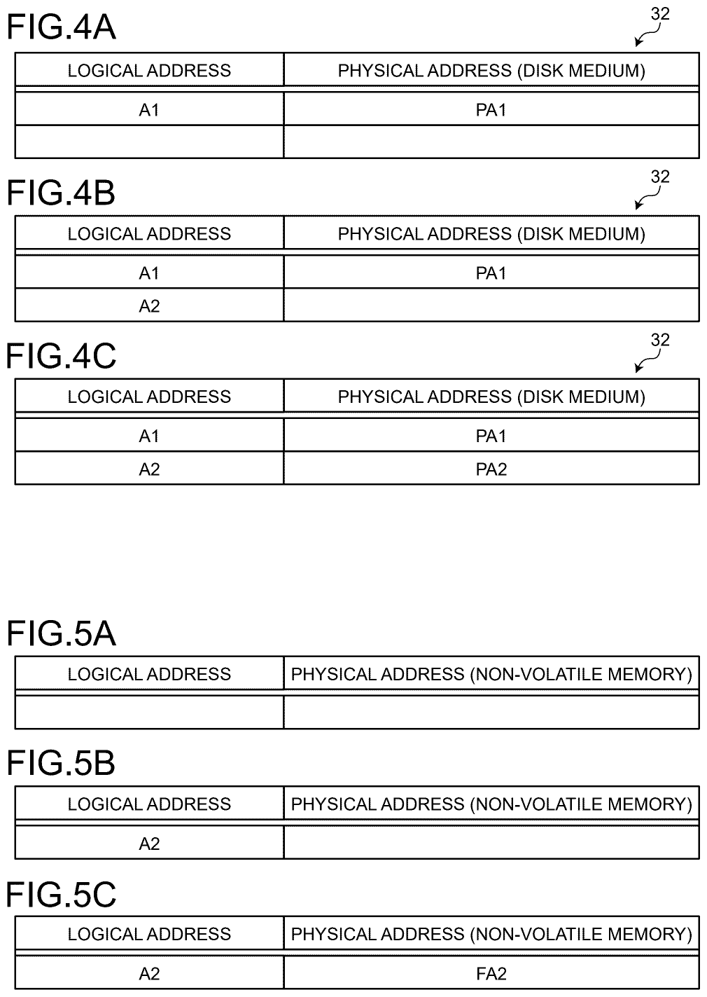

For example, it is assumed that the command processing of a write command CM1 including a logical address A1 and the data D1 has been completed, and the write operation of the data D1 to a physical address PA1 of the disk medium 11 has also been completed. In this case, as illustrated in FIG. 4A, the logical address A1 and the physical address PA1 of the data D1 are registered in the address translation information 32 of the volatile memory 29. FIGS. 4A to 4C are diagrams illustrating registered contents of the address translation information 32. As illustrated in FIG. 5A, the address translation information 33 of the volatile memory 29 is empty. FIGS. 5A to 5C are diagrams illustrating registered contents of the address translation information 33. The volatile memory 29 temporarily stores the data D1.

The controller 30 waits until a write command is received (No in S1). In a case where the write command has been received (Yes in S1), the controller 30 accesses the volatile memory 29 and updates the address translation information 32 according to the contents of the write command. For example, in a case where a write command CM2 including a logical address A2 and the data D2 is received, the controller 30 registers the logical address A2 in the address translation information 32 as illustrated in FIG. 4B. In this case, the volatile memory 29 temporarily stores the data D1 and the data D2 individually. The volatile memory 29 can store information indicating that the logical addresses of the data D1 and the data D2 are A1 and A2, respectively.

The controller 30 determines a physical address PA2 of a write destination corresponding to the logical address A2 of the data D2 (S2). As illustrated in FIG. 4C, the controller 30 associates the physical address PA2 with the logical address A2 and registers the physical address PA2 in the address translation information 32. As a result, the command processing of the write command CM2 is completed.

The controller 30 refers to the address translation information 32 of the volatile memory 29 and specifies that the data written immediately before the data D2 is D1, and the logical address thereof is A1 as illustrated in FIG. 4C. The controller 30 acquires the data D1 and the logical address A1 from the volatile memory 29 (S3).

The controller 30 uses at least part of the data D1 as an encryption key (S4). The controller 30 may use part of the beginning of the data D1 as an encryption key, or may use the entire data D1 as an encryption key. In this case, the controller 30 sets the logical address of the encryption key to A1.

The controller 30 encrypts the data D2 with the encryption key to generate encrypted data D2a (S5). The logical address A1 of the encryption key, the encrypted data D2a, and the logical address A2 are stored in the volatile memory 29 (S6). In this case, since there is a possibility that the encrypted data D2a is backed up in the non-volatile memory 28, the controller 30 may register the logical address A2 in the address translation information 33 of the volatile memory 29 as illustrated in FIG. 5B.

The controller 30 determines whether power interruption has occurred or not (S7). For example, in a case where the power supplied from the power supply circuit 20 is more than a threshold value, the controller 30 may determine that no power interruption has occurred, and in a case where the power supplied from the power supply circuit 20 is equal to or less than the threshold value, the controller 30 may determine that power interruption has occurred.

In a case where the power interruption has occurred (Yes in S7), the controller 30 determines a physical address FA2 of a backup destination corresponding to the logical address A2 of the encrypted data D2a (S8). As illustrated in FIG. 5C, the controller 30 associates the physical address FA2 with the logical address A2 and registers the physical address FA2 in the address translation information 33. The controller 30 stores the address translation information 33 in the' management information storage area of the non-volatile memory 28 in the controller 30. At the same time, the controller 30 backs up the logical address A1 of the encryption key, the encrypted data D2a, the logical address A2, and the address translation information 32 in a storage area of the non-volatile memory 28 (S9). The controller 30 stores the logical address A1 of the encryption key, the encrypted data D2a, the logical address A2, and the address translation information 32 in the physical address FA2 of the non-volatile memory 28. As a result, the encrypted data D2a corresponding to the data D2 being written can be backed up in a non-volatile manner.

In a case where no power interruption has occurred (No in S7), the controller 30 erases the logical address A2 and the physical address FA2 from the address translation information 33 to return the state to be empty illustrated in FIG. 5A, and writes the data D2 to the disk medium 11 (S10). The controller 30 writes the data D2 to the physical address PA2 of the disk medium 11. As a result, the write processing of the data D2 can be completed.

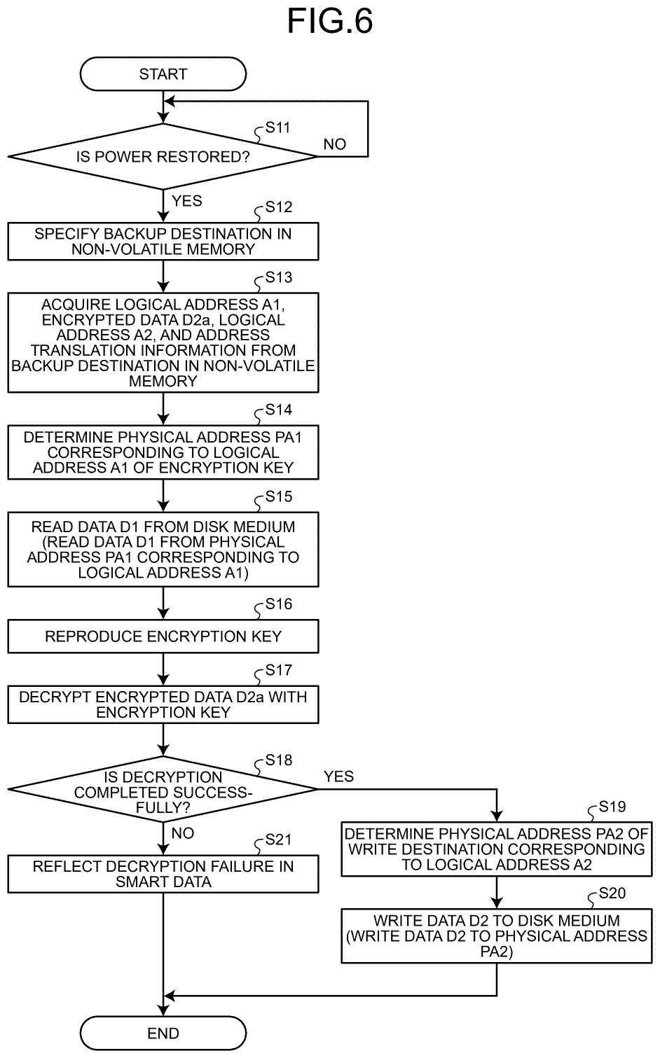

The disk device 1 may perform an operation as illustrated in FIG. 6 related to the power restoration. FIG. 6 is a flowchart illustrating an operation related to the power restoration of the disk device 1.

The controller 30 waits until the power is restored (No in S11). In a case where the power supplied from the power supply circuit 20 is equal to or less than a threshold value, the controller 30 may determine that the power has not been restored, and in a case where the power supplied from the power supply circuit 20 is more than the threshold value, the controller 30 may determine that the power has been restored.

In a case where the power has been restored (Yes in S11), the controller 30 loads the address translation information 33 from the management information storage area of the non-volatile memory 28 in the controller 30 to the volatile memory 29. The controller 30 refers to the address translation information 33 and specifies a backup destination in the non-volatile memory 28 (S12). As illustrated in FIG. 5C, the controller 30 may specify the physical address of the non-volatile memory 28 to FA2 as the backup destination.

The controller 30 acquires the logical address A1, the encrypted data D2a, the logical address A2, and the address translation information 32 from the backup destination in the non-volatile memory 28 (S13). The controller 30 may load the physical address of the non-volatile memory 28, including the logical address A1, the encrypted data D2a, the logical address A2, and the address translation information 32, from FA2 to the volatile memory 29. The controller 30 identifies the logical address A2 as the logical address of the encrypted data D2a and identifies the logical address A1 as the logical address of the encryption key according to the address translation information 33.

The controller 30 determines the physical address PA1 corresponding to the logical address A1 of the encryption key according to the address translation information 32 (S14).

The controller 30 accesses the physical address PA1 of the disk medium 11 and reads the data D1 from the physical address PA1 of the disk medium 11 (S15).

The controller 30 reproduces at least part of the data D1 as an encryption key (S16). In a case where the part of the beginning of the data D1 is used as the encryption key in S4, the controller 30 reproduces the part of the beginning of the data D1 read in S15 as an encryption key. In a case where the entire data D1 is used as the encryption key in S4, the controller 30 reproduces the entire data D1 read in S15 as an encryption key.

The controller 30 decrypts the encrypted data D2a with the encryption key reproduced in S16 (S17).

In a case where the decryption is completed successfully (Yes in S18), the controller 30 obtains the decrypted data D2. The controller 30 determines the physical address PA2 of the write destination corresponding to the logical address A2 according to the address translation information 32 (S19).

The controller 30 accesses the physical address PA2 of the disk medium 11 and writes the data D2 to the physical address PA2 of the disk medium 11 (S20). As a result, the writing of the data D2 backed up when the power interruption occurs to the disk medium 11 is completed.

In a case where the decryption has failed (No in S18), the controller 30 reflects the decryption failure in the SMART data (S21). As a result, it can be managed that the data D2 has been lost due to the decryption failure.

As described above, in the embodiment, in the disk device 1, the data being written is encrypted with the written encryption key and is backed up in the non-volatile memory 28 in the controller 30 when the power interruption occurs. As a result, both the security assurance and the backup of the data being written can be achieved, and the data can be appropriately backed up.

Furthermore, in the embodiment, in the disk device 1, the controller 30 is configured as a system-on-a-chip, and the non-volatile memory 28 is mounted in the controller 30 as a part of the system-on-a-chip. As a result, unless the system-on-a-chip is destroyed, the non-volatile memory 28 cannot be physically contacted, and unless the data on the disk medium 11 is used as the encryption key, the encrypted write data cannot be decrypted, so that the security of the data to be backed up can be reliably assured.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a disk medium to which first data is written;
a volatile memory that is capable of temporarily storing the first data and second data; and
a controller that includes a processor acquiring at least part of the first data as an encryption key when power interruption occurs and encrypting the second data with the encryption key, and a non-volatile memory storing the encrypted second data when the power interruption occurs.

2. The disk device according to claim 1, wherein
the controller is configured as a system-on-a-chip.

3. The disk device according to claim 1, wherein
the processor acquires part of a beginning of the first data as an encryption key and encrypts the second data with the encryption key when the power interruption occurs.

4. The disk device according to claim 1, wherein
the processor acquires an entirety of the first data as an encryption key and encrypts the second data with the encryption key when the power interruption occurs.

5. The disk device according to claim 1, wherein
the processor stores the encrypted second data in the non-volatile memory when the power interruption occurs.

6. The disk device according to claim 1, wherein
the processor further stores address information of the first data and address information of the second data in the non-volatile memory when the power interruption occurs.

7. The disk device according to claim 6, wherein
the first data and the second data are both data after being subjected to command processing,
the volatile memory is further capable of storing first address translation information including a logical address of the first data and a logical address of the second data, and
the first data is data registered in the first address translation information immediately before the second data.

8. The disk device according to claim 7, wherein
the first data is data after being written to the disk medium.

9. The disk device according to claim 7, wherein
the first address translation information further includes a physical address of the first data in the disk medium in association with the logical address of the first data.

10. The disk device according to claim 7, wherein
the processor further stores the first address translation information in the non-volatile memory when the power interruption occurs.

11. The disk device according to claim 7, wherein
the volatile memory is further capable of storing second address translation information including the logical address of the second data.

12. The disk device according to claim 11, wherein
the first address translation information further includes a physical address of the first data in the disk medium in association with the logical address of the first data, and
the second address translation information further includes a physical address of the second data in the non-volatile memory in association with the logical address of the second data.

13. The disk device according to claim 12, wherein
the processor further stores the first address translation information and the second address translation information in the non-volatile memory when the power interruption occurs.

14. The disk device according to claim 1, wherein
the processor writes the second data to the disk medium in a case where the power interruption does not occur.

15. The disk device according to claim 6, wherein
the processor reads the encryption key from the disk medium, reads the encrypted second data from the non-volatile memory, and decrypts the encrypted second data with the encryption key when power restoration occurs.

16. The disk device according to claim 10, wherein
the processor reads the first address translation information from the non-volatile memory and reads the encryption key from the disk medium according to the first address translation information when power restoration occurs.

17. The disk device according to claim 13, wherein
the processor reads the first address translation information from the non-volatile memory, reads the encryption key from the disk medium according to the first address translation information, reads the second address translation information from the non-volatile memory, reads the encrypted second data from the non-volatile memory according to the second address translation information, and decrypts the encrypted second data with the encryption key when power restoration occurs.

18. The disk device according to claim 15, wherein
the processor writes the decrypted second data to the disk medium when the power restoration occurs.

19. The disk device according to claim 16, wherein
the processor updates the first address translation information and writes the decrypted second data to the disk medium after the decryption is completed when the power restoration occurs.

20. The disk device according to claim 19, wherein
in a case where the decryption fails when the power restoration occurs, the processor reflects the decryption failure in SMART (Self-Monitoring Analysis and Reporting Technology) data.
